(19) United States
(12) Patent Application Publication
(10) Pub. No.: US 2016/0219856 A1
(43) Pub. Date: Aug. 4, 2016

(54) Fishing lure retriever

(71) Applicant: Walter Ray Henderson, Stone Mountain, GA (US)

(72) Inventor: Walter Ray Henderson, Stone Mountain, GA (US)

(21) Appl. No.: 14/612,507

(22) Filed: Feb. 3, 2015

(51) Int. Cl. A01K 97/24

(52) U.S. Cl. CPC A01K 97/24

(57) ABSTRACT

A fishing lure retriever that is used to be attached to a plurality of sized fishing line for the purpose of retrieving a snagged lure(s) underneath the surface of water. The fishing lure retriever can be used for fresh or saltwater fishing applications. Once the apparatus is correctly attached onto a plurality of sized fishing line by a plurality of attachment methods, the plurality of sized fishing line is stretched tight with the tip of the rod raised vertical to the water's surface. The lure retriever is released on the plurality of sized fishing line in a free fall descent, descending beneath the surface of the water and freeing the snagged lure. The fishing lure retriever has a bullet like shape, made of metal, light weight, small and can be easily stored in small compartments including comfortably secured in the anglers shirt and or pants pocket.

### BACKGROUND

It is logical it assume that even in ancient time's underwater structure and cover existed thus leaving those anglers to grappled with the issues of snagged lures some attempted solutions have tried to solve the problems of snagged underwater lures. The issues that most inventors face when developing an effective lure retriever apparatus is to grapple with the development of an apparatus by combines all the disadvantages of currently used apparatuses thus creating a new apparatus and its method of attachment. Currently there are three common types of lure retriever categories used to solving the problems associated with fishing lure retrievers and they are; Pole Retriever and Chain and Weight fishing lure retrievers.

### Pole Lure Retriever

the pole lure retrievers I will be referencing from U.S. Pat. No. 6,694,664 Knight, U.S. Pat. No. 6,305,119 Kacak and U.S. Pat. No. 4,622,772 to illustrate the typical or common problems existing in this category. Pole lure retrievers are basically a telescope like connecting poles that attaches to fishing line. The fishing line is without any slack and kept tight while the pole retriever, attaches to the fishing line at the rods tip, and is descended underwater at a depth that reaches and frees the snagged fishing lure.

one of several disadvantages of the Pole lure Retrievers is its length. They are assorted pieces that adjust to the angler's desired depth and are only effective in depth that are not limited to their length. For example a rod retriever having a maximum depth of 16 feet doesn't have any functionality in retrieving a snagged lure in a depth 17 feet deep or more. This disadvantage also effects the apparatuses durability and its awkwardness when being used single handed. Pole retrievers are heavy and are more expensive than other types of lure retrieves.

Lastly the Pole lure retriever Inventors didn't account for all the room this lure retriever takes up in a small boat and because the lure is placed together in sections, this lure being dropped overboard accidentally is a very common occurrence.

### Chain and Weight

The Chain and Weight lure retriever's reference U.S. Pat. No. 8,302,344 Pickens, U.S. Pat. No. 6,442,886 McAfee and U.S. Pat. No. 4,408,411 Skarnells to illustrate to typical problems existing in this category. Chain and Weight lure retrievers, is a lure retriever that clips on a fishing line and slides down the fishing line to knock the fishing lure loose. Chain and weight retrievers are commonly prone to tangling, the apparatus works well only when the angler is positioned directly over the lure. Chain and Weight lure retrievers are all usually heavy which causes snags and abrasions in the line and line breakage.

Other disadvantages to the chain and weight lure retrievers include going in a spindly bush or tree, as the retriever or cord may get caught up in the snag and struggle to make it down to the lure. Lastly, the Chain and weight lure retriever can only push and not pull lures free.

### Our Solution

our solution of effectively creating a lure retriever apparatus is as follows: Our apparatuses size. The small size and having two fishing line attachments makes operating the apparatus easy to manage and operate, less awkward to use, easy to store, transport and quick to set up.

Our apparatus can be operated from any shorelines which includes and not limited to banks, rivers, lakes, boats, docks, and bridges and is effectiveness in any depth of the of water to retrieve snagged lures.

our lure retriever apparatus is free of any tread, twine, rope or chain or anything that could cause tangling or obstruction while retrieving the underwater fishing lure.

Our apparatus is effective in retrieving a fishing lure from underwater where the line is going through brush or tree cover the apparatus because of its size, shape and weight of material will virtually go through this type of cover without being entangled or snagged its self to retriever the snagged lure.

Because of our apparatuses design, weight and fishing line attachments the apparatus will not cause abrasions in the fishing line that may cause line breakage or damage the snagged lure in any way.

### SUMMARY OF THE INVENTION

When a fishing lure is snagged under the surface of the water. The angler has a choice as to what method of attachment he/she will deploy to retrieve the snagged lure. Methods to be considered for attaching the apparatus to the fishing line is either by attaching the fishing line to the outer mechanism assembly receivers or the inner mechanism assembly receivers. Both attachment methods are quick and easy attachments but the external method is a new method of attaching fishing line to the apparatus in a series of steps specifically created for the outer mechanism assembly receivers.

Once the fishing line is attached, the line is stretched and the apparatus free falls on the fishing line to the snagged lure underneath the surface of the water. If the lure is not free from the snag the angler's alternative is shaking the line until snag is cleared. The device is hand held, bullet like in shape, light weight and is small enough to be placed comfortably in a small compartment, tackle boxes, pants, shirts, or jacket pockets. Both ways of attaching the device to the fishing line is fast, efficient, tangle and snag proof and will allow the angler the benefit of optimal lure retrieving.

### BRIEF DESCRIPTION OF THE DRAWINGS

FIG. 1 front perspective view of a lure retriever.

FIG. 2 back perspective view a lure retriever.

FIG. 3 right side perspective view a lure retriever.

FIG. 4 top perspective view a lure retriever.

FIG. 5 bottom perspective view a lure retriever.

FIG. 6 Bottom perspective view of a lure retriever.

6-1 Housing Canal

FIG. 7 Top side view of a lure retriever illustrating;

7-1 Operational platform

7-2 Close platform receiver

7-3 open entry platform receiver.

FIG. 8 Is a prospective views of the handheld housing centralized core unit without the inner/outer mechanism assembly receivers.

FIG. 9 Is a South West Isometric perspective view of the outer mechanism assembly receiver illustrating;

9-1 Operations bar,

9-2 harness assembly post,

9-3 open ended inverted positional loop receiver.

FIG. 10 is a prospective view of the outer mechanism assembly receiver illustrating;

10-1 Mechanism bolt,

10-2 mechanism tube,

FIG. 11 is a top view inside perspective of the mechanism bolt illustrating;

11-1 open and close entry blocks

11-2 magnets thereof;

FIG. 12 is a vertical perspective positional view of the of both the inner and outer mechanism assembly receivers.

12-1 inner and outer mechanism assembly receivers.

12-2 fishing line receiver canal

FIG. 13 is a vertical perspective view of the inner mechanism assembly receiver illustrating;

13-1 turn-key knob

13-2 enclosure ring

13-3 tubal flange

13-4 mechanism shaft thereof;

FIG. 14 Is the Alternative position view illustrations for using the external shoulder attachment method

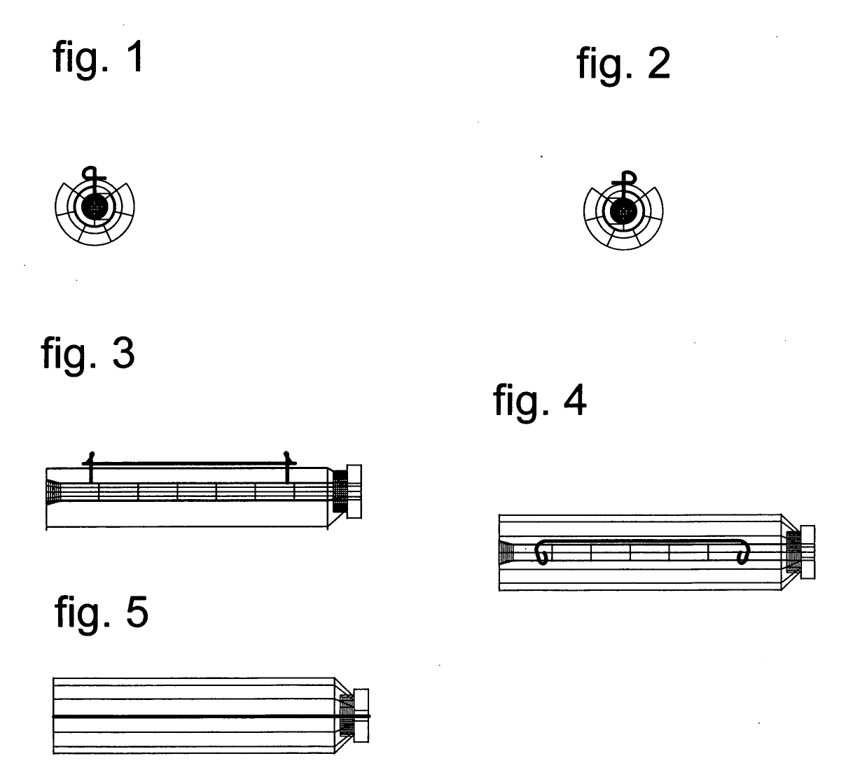

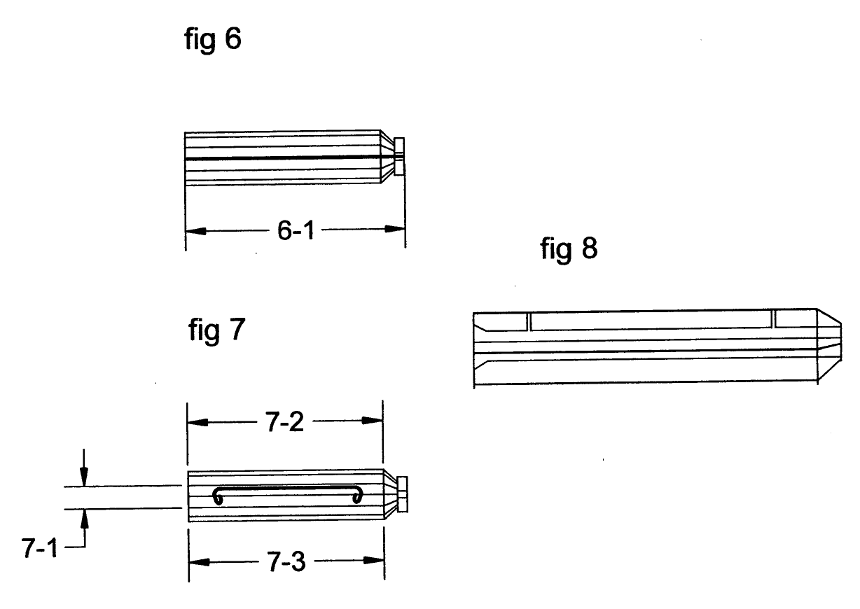

14-1 Illustration shows a plurality of fishing lines looped structure is pushed through the operational platforms, open ended platform receiver and the closed operational platform.

14-2 Illustration shows a plurality of fishing lines looped structure right sleeve is placed over and across and underneath the lure retriever's right shoulder and front-end.

14-3 Illustration shows a plurality of fishing lines looped structure left sleeve is placed over and across and underneath the lure retrievers left shoulder and back-end.

14-4 Illustration by pulling the ends of the plurality of sized fishing lines simultaneously from opposite ends of the apparatus the plurality of sized fishing line is attached to the apparatus and the external shoulder attachment method is complete.

FIG. 15 a bottom view of the lure retrievers housing canal entry

FIG. 16 a right view demonstrating a plurality of size fishing line attached using the housing attachment method.

### DETAILED DESCRIPTION OF THE INVENTION

### 37. Overview

A lure retriever apparatus that has a plurality of methods used to attach a plurality of sized fishing line to retrieve snagged lures beneath the surface of water. The lure retriever is small in size and lightweight and can be easily attached/detached to a plurality of sized fishing line. The lure retriever consist of the handheld housing, an outer mechanism assembly receiver and the inner mechanism assembly receivers as well as having a plurality of methods of attaching sized fishing line to the apparatus.

### 38. Handheld Housing

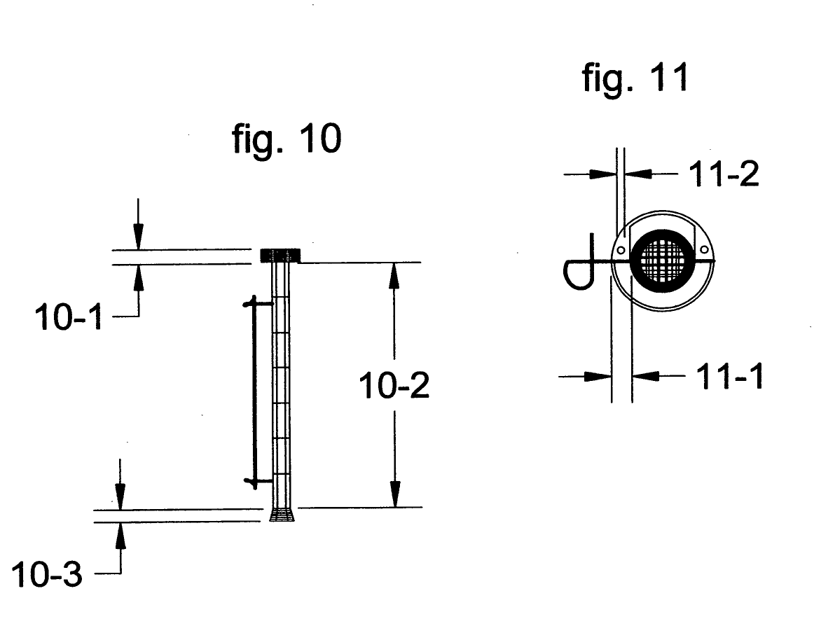

The Handheld housing is the body of the lure retriever. The handheld housing has an operation platform 7-1 and a centralized core FIG. 8 used to position and enclose outer mechanism assembly receivers FIG. 10 and the inner mechanism assembly receivers FIG. 13 of the lure retriever. The handheld housing is bullet like in shape and is made of metal. The weight of the lure retriever is such, that when the lure retriever is attached to a plurality of sized fishing line, by either method of fishing line attachments. The weight of the lure retriever will not cause abrasion damage to the plurality of size fishing line and is heavy enough to bypass debris or many other types of obstruction to free the snagged lure.

### 39. Outer Mechanism Assembly Receiver

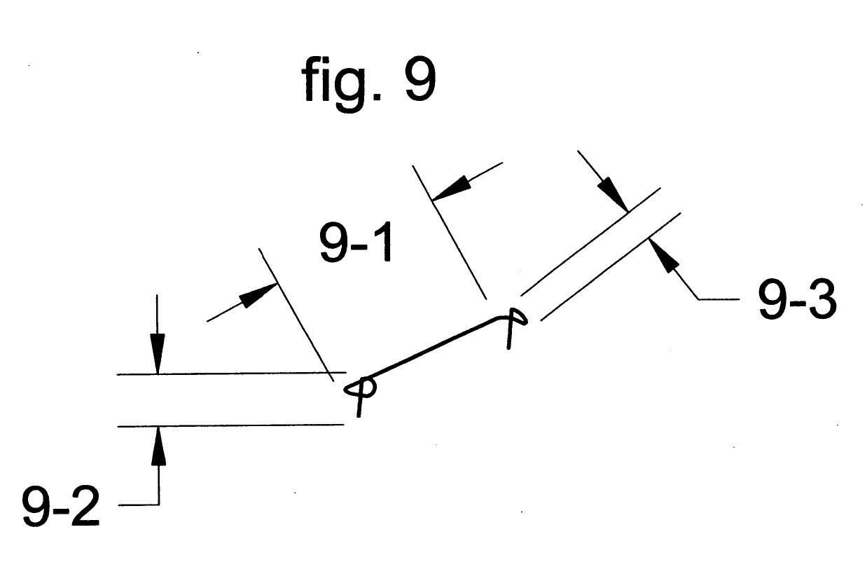

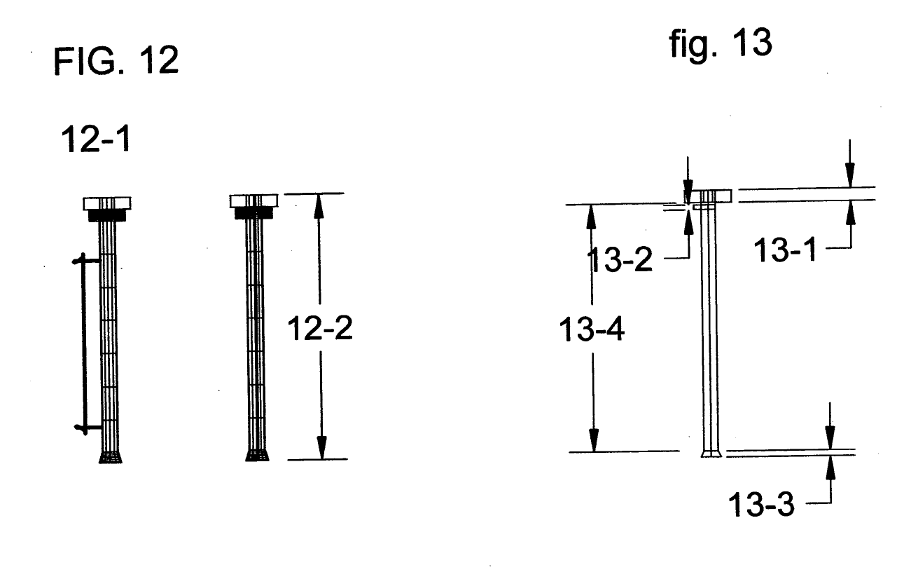

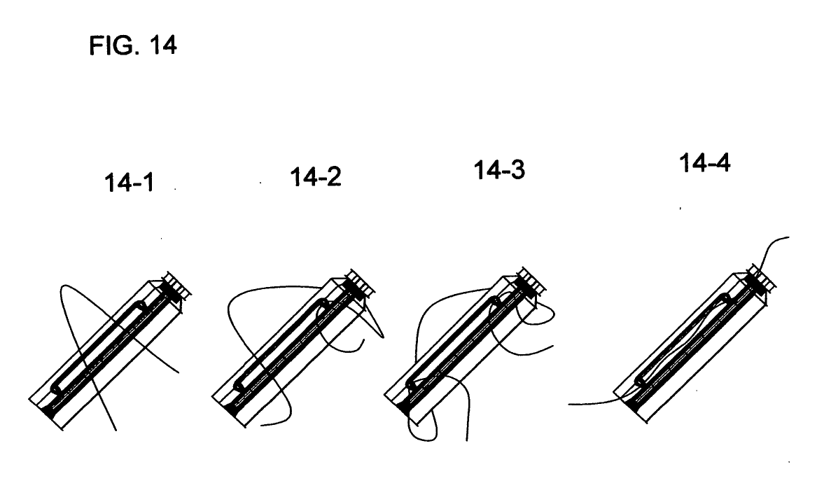

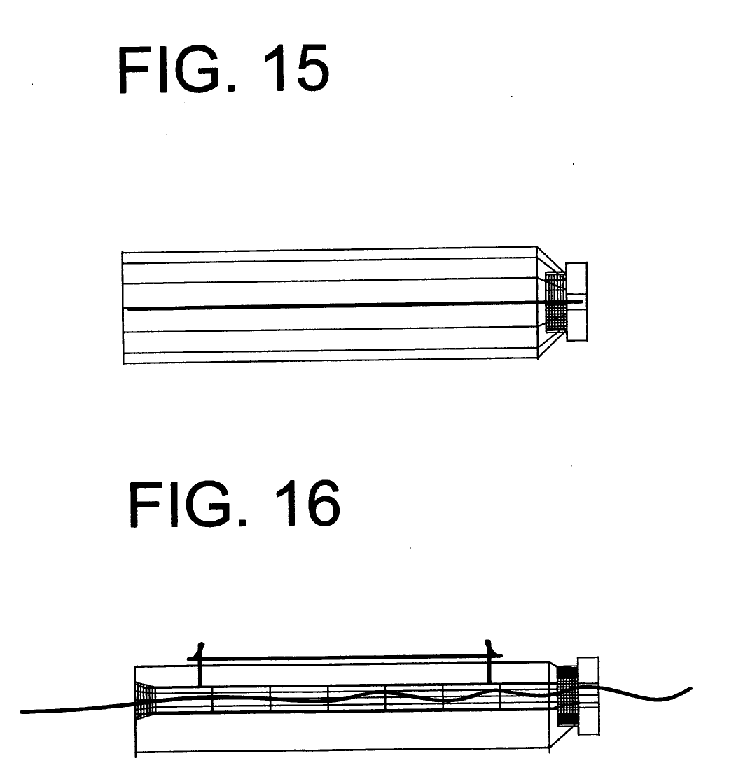

The Outer mechanism assembly receiver FIG. 10 has several important functions. They include but not limited to attaching a plurality of sized fishing line to the lure retriever FIG. 14 The outer part of the assembly is located adjacent to the handheld housings operations platform as shown in FIG. 9 The outer unit of the outer mechanism assembly receiver FIG. 10 consist of an operations bar 9-1, a plurality of harness assembly posts 9-2 and a plurality of open ended inverted assembly receivers 9-3 as illustrated in FIG. 9 The outer mechanism assembly receiver FIG. 10 is extended to the operational platform 7-1 by a plurality of harness assembly posts 9-2. Here also as shown in FIG. 9, the operations bar 9-1 adjoins the closed platform receiver 7-2. The purpose served by position of the operations bar 9-1 and the closed platform receive 7-2 is an indicator to the angler that this is not the entry used to place a plurality of fishing line when performing the loop line set method shown in FIG. 14 Inside the handheld housing is the mechanism tube 10-2. That is an enclosure for the inner mechanism assembly shown in FIG. 12 The outer mechanism assembly receiver FIG. 10 that is positioned inside the handheld housings centralized core FIG. 8 keeps the inner mechanism assembly FIG. 13 positioned and helps with the canal alignment for Housing Attachment method of plurality of fishing line.

### 40. Inner Mechanism Assembly Receivers

The Inner mechanism assembly receivers FIG. 16 is the where the plurality of sized fishing line comes is entered when using the housing attachment method. The inner mechanism assembly, receiver FIG. 13 consist is of a tubal flange 13-3, inner mechanism shaft 13-4, and a receiver turn-key knob 13-1. The tubal flange 13-3 is the base beveled end of the inner mechanism assembly receiver. The tubal flange 13-3 function is used to keep the unit securely in place and rotate inner the mechanism assembly receiver inside of the outer mechanism receivers. The inner mechanism shaft 13-4 has an elongated body and is used to encase the plurality of sized fishing line. The head of the inner mechanism assembly receiver is receiver turn-key knob 13-1. The function of the receiver turn-key knob 13-1 is to open and close the handheld canal 6-1 when placing a plurality of sized fishing line to the lure retriever. To open or close the handheld canal 6-1 passage the turn-key knob 13-1 is turned to the right clockwise to open and counter clockwise close. The units' enclosure ring 13-2 is used to stabilize the open and closed position by magnets 11-2 inside the outer mechanism assembly's mechanism bolts 10-1 open and closed entry blocks 11-1.

### 41. The Loop Line Set Method

FIG. 14 Illustrates the alternative position views of attaching a plurality of sized fishing line to the handheld housing. By placing the distal ends of the plurality of sized fishing line together the plurality of sized fishing line forms a looped structure 14-1. While the center of the looped structure is stationary, place line over and around the right shoulder of the handheld housing 14-2 Then place the left sleeve is placed over and around the left shoulder of the lure retriever's handheld housing 14-3. Then pulling the distal ends of a plurality of sized fishing line of opposite ends of the lure retrievers handheld housing 14-4. The plurality of sized fishing line is attached to the lure retriever's handheld housing completing line attachment. To remove the attached plurality of sized fishing line from the lure retriever's handheld housing. The angler reverses the steps of the External Shoulder attachment method.

### 39. Housing Attachment Method

The housing attachment method is one of a plurality of the lure retriever attachments. To attach the fishing line to the lure retriever the turn-key knob 13-1 is turned clockwise to open the lure retrievers housing canal 6-1. Then, the plurality of sized fishing line is placed inside and is secured in place by turning the turn-key knob 131-1 counter clockwise closing the lure retrievers housing canal 6-1. After performing a successful retrieval the plurality of sized fishing line is detached from the lure retriever by turning the turn-key knob clockwise 13-1 to open the lure retrievers housing canal 6-1.

What is claimed:

1. A lure retriever comprising: a handheld housing unit; a plurality of outer mechanism assembly receivers; a plurality of inner mechanism assembly receivers.

2. The lure retriever as in claim 1 wherein the said handheld housing has a plurality of size and weight whereas a plurality of size and a plurality weight gives optimal support to the plurality of a sized fishing line.

3. The lure retriever as in claim 1 wherein the right shoulder is adjacent to the front-end point of said handheld housing.

4. The lure retriever as in claim 1 wherein the left shoulder is adjacent the back-end of said handheld housing.

5. The lure retriever as in claim 3 wherein the left shoulder of said handheld housing is the opposite side of impact because of the contour of its shape and the drag force placed on it when in retrieval operation.

6. The lure retriever as in claim 1 wherein the right shoulder of said handheld housing is pointed which limits drag force and resistance from debris or other types of obstruction.

7. The lure retriever as in claim 5 wherein the pointed end is the opposite side of impact of the said handheld housing whereas the distance of impact and pointed contour of the point dissipates the drag force exerted on the apparatus.

8. The lure retriever as in claim 1 wherein the material used is made of metal of the said handheld housing whereas the material used is both optimal in size and weight that does not cause abrasion to the plurality of sized fishing line and durable enough to free snagged lures.

9. The lure retriever as in claim 1 wherein a plurality of operational platforms is coupled to the width of said handheld housing whereas a plurality of operational platforms is designated area on the apparatus as a plurality of attachment methods.

10. The lure retriever as in claim 8 wherein an open entry platform receiver is dispose of on the said operational platform wherein the open platform receiver is positioned to correspond with steps in a plurality of sized fishing line to lure retriever using a plurality of attachment methods.

11. The lure retriever as in claim 8 wherein a closed platform receiver is dispose of on said plurality of operational platforms wherein the closed platform receiver is positioned to correspond with steps in a plurality of sized fishing line to lure retriever using a plurality of attachment methods.

12. The lure retriever as in claim 8 wherein the open entry platform receiver is adjacent to the said closed operational platform receiver wherein the open platform receiver is positioned to correspond with steps in a plurality of sized fishing line to lure retriever using a plurality of attachment methods.

13. The lure retriever as in claim 1 wherein a centralized core is dispose of in of said of handheld housing where the centralized core encloses both an outer and mechanism assembly receivers as a Plurality of attachment methods.

14. The lure retriever as in claim 1 further comprising of a plurality of outer mechanism assembly receiver is dispose of in the centralized core that attaches a plurality of sized fishing line to the apparatus.

15. The lure retriever as in claim 1 wherein a plurality of outer mechanism assembly receivers comprises of the mechanism tube that is used to chamber the inner mechanism assembly receivers as a plurality of attachment methods.

16. The lure retriever as in claim 1 wherein a plurality of outer mechanism assembly receiver comprises of a plurality of harness assembly post which supports a plurality of open ended inverted positional loop receivers and operations bar as a plurality of attachment methods.

17. The lure retriever as in claim 1 wherein a plurality of outer mechanism assembly receiver comprises of a plurality of open ended inverted positional loop receivers wherein the open ended inverted positional loop receivers attaches to a plurality of sized fishing line.

18. The lure retriever as in claim 1 wherein a plurality of outer mechanism assembly receivers comprises of an operations bar wherein the operations bar is steps of operation of a plurality of sized fishing line attachment to a plurality of attachment methods.

19. The lure retriever as in claim 10 wherein the operations bar is adjacent to said closed platform receiver whereas the operations bar and closed platform receiver are the closed entry side of the operations platform and prevent entry of a plurality of sized fishing line when using one of the plurality of attachment methods.

20. The lure retriever as in claim 1 wherein a plurality of outer mechanism assembly receiver comprises of the mechanism bolt whereas the mechanism bolt stabilizes functionality both the inner and outer mechanism assembly receivers.

21. The lure retriever as in claim 19 wherein of said mechanism bolt is coupled to the mechanism tube whereas the mechanism tube is the main body outer mechanism assembly receiver and encloses the main body of the inner mechanism assembly receiver, the inner mechanism shaft.

22. The lure retriever as in claim 19 wherein a plurality of OC (open/closed) entry blocks are dispose of within of said mechanism bolt whereas a plurality of OC entry blocks position the enclosure ring to the open or closed position.

23. The lure retriever as in claim 21 wherein a plurality of said OC (open/closed) entry blocks comprises of a plurality of magnets whereas the magnets ensure the enclosure ring is kept in either open or closed position during and after lure retrieval.

24. The lure retriever as in claim 14 wherein a plurality of harness assembly posts is coupled to the said mechanism tube whereas when coupled with said mechanism tube, a plurality of harness assembly posts is the base support for the plurality of open ended inverted positional loop receivers and the operations bar.

25. The lure retriever as in claim 16 wherein a plurality of harness assembly posts is coupled to said a plurality of open ended inverted positional loop receivers.

26. The lure retriever as in claim 16 wherein an operations bar is coupled to a plurality of said open ended inverted positional loop receivers. The lure retriever as in claim 1 further comprising of a plurality of inner mechanism assembly receivers dispose of in a plurality of outer mechanism assembly receivers use to attach the a plurality of sized fishing line to a plurality of attachment methods.

27. The lure retriever as in claim 1 wherein a plurality of said inner mechanism assembly receiver comprises of a rotary enclosure ring used to either open or close the housing canal for securing the entry or removal of a plurality of sized fishing line to the apparatus.

28. The lure retriever as in claim 1 wherein a plurality of said inner mechanism assembly receivers comprises of an inner mechanism shaft that is used to enclose a plurality of sized fishing line.

29. The lure retriever as in claim 1 wherein a plurality of said inner mechanism assembly receiver comprises of a receiver turn-key knob used to open or close the entry fishing line receiver canal.

30. The lure retriever as in claim 1 wherein a plurality of said inner mechanism assembly receivers comprises of a tubal flange that is used in aiding to the rotation of a plurality of said inner mechanism assembly receivers, and securing the inner mechanism assembly receiver to the outer mechanism assembly receiver.

31. The lure retriever as in claim 19 wherein the rotary enclosure ring is dispose of in the said mechanism bolt.

32. The lure retriever as in claim 28 wherein the receiver turn-key knob is coupled to the said mechanism shaft that tongues the rotary enclosure ring to its open or closed position.

33. The lure retriever as in claim 28 wherein the rotary enclosure ring is displaced onto the said mechanism shaft used to either open or close the housing canal for securing the entry or removal of a plurality of sized fishing line to the apparatus.

34. The lure retriever as in claim 28 wherein the tubal flange is coupled to the said mechanism shaft that is used to help position and secure the plurality of inner mechanism assembly receivers disposed of in a plurality of outer mechanism assembly receivers.

35. A method of attaching a lure retriever to a plurality of size fishing line comprising the steps of: holding the said handheld housing in the correct position to begin attachment operations; creating a loop structure from portion of said fishing line and pushing it into the cavity of said outer mechanism assembly receivers and across said operational platforms and extending said loop structure beyond said handheld housing; pulling a portion of said loop structures right sleeve over and across said right shoulder of said handheld housing; pulling a portion of the said loop structures left sleeve over and across the said left shoulder of the said handheld housing, from each opposite end of the retriever, simultaneously pull the fishing line, thus connecting the said fishing line connecting the said lure retriever; and reversing the functions of said claims, detaches the said plurality of sized fishing line from the said lure retriever.

36. The method of attaching a lure retriever as in claim 36 further comprising the steps of: said plurality of size fishing line is disposed of in the said inner mechanism assembly receivers, said plurality of size fishing line is pushed through the said entry fishing line receiver canal, through the mechanism tube canal, through the mechanism bolt canal, receiver turn-key knob canal and is enclosed inside the said mechanism tube canal and secured its entry and exit by said receiver turn-key knob, thus connecting said plurality of size fishing line to said lure retriever.
